(19) United States
(12) Patent Application Publication
(10) Pub. No.: US 2006/0194186 A1
(43) Pub. Date: Aug. 31, 2006

(54) Method and apparatus for automatically grouping within a networking database and system for parents

(76) Inventor: Amit Nanda, Fremont, CA (US)

Correspondence Address: Bayshore Patent Group, LLC, 520 Chantecler Dr., Fremont, CA, 94539, US

(21) Appl. No.: 11/363,910

(22) Filed: Feb. 28, 2006

Related U.S. Application Data
(60) Provisional application No. 60/657,153, filed on Feb. 28, 2005.

(51) Int. Cl. G09B 3/00

(52) U.S. Cl. 434/350

(57) ABSTRACT

A method and apparatus for automatically grouping parents, especially for parents of school-going children, who have been connected to one another in a randomly formed networking database. Each parent-user has provided information about themselves (ethnicity, religion, occupation, education, hobbies, interests etc.) and their children (school, hobbies, interests etc.), which is stored as a unique record in the database. A deterministic software algorithm uses parent records to form groups of parents. The algorithm automatically groups parents in a manner that creates an affinity between them (for example, based on the real world school relationships between their children, based on membership in a soccer club, mother's club, scout groups etc.). Once the groups are formed parent-users can filter incentives-based member-generated content using the grouping system.

This application claims priority to U.S. Provisional Patent Application serial No. 60/657,153, filed Feb. 28, 2005 and is herein incorporated by reference in its entirety.

### FIELD OF THE INVENTION

This application relates to a computer software algorithm and, specially, to a method and apparatus for automatically grouping, incentives-based content generation and content filtering within an online network of parents.

### BACKGROUND OF THE INVENTION

With the remarkable growth and spread of the Internet and the World Wide Web (“the Web”) in recent years, individuals can create a relationship with another, whom they have never met, by association through databases. Individuals can become part of a database through a Web-site of the database services provider on the Internet. This is done in a conventional manner by accessing the Web-site through an Internet service provider. Once the user has logged into the Web-site, he or she can input some information and invite other individuals to become members, thereby proceeding the registration process. Each individual who is a registered member can provide additional information and such information becomes part of the database associated with the individual. Although the first searching individual may not personally know the second and the following individuals in the online network, they can be linked or interconnected by chains of defined relationships as indicated in U.S. Pat. No. 6,175,831. Online networks are typically used to connect individuals based on chains of defined relationships. However it is also possible to form interest-based groups of individuals. Such interest-based groups are typically formed around a particular topic of interest or characteristic and are therefore called topic-centric. In a topic-centric online group, users manually join a forum or similar interaction venue, in which they are able to discuss a specific topic with people who have a shared interest (i.e., Sky diving). Topic-centric groups are commonly formed in conventional Web-site services or in online network services.

Other conventional Web-site services relate to the mechanism by which people-centric groups are formed in an online setting. Such Web-site services enable individuals to manually invite others they know into people-centric groups (i.e., students working together on a class project). This group formation requires a group leader and moderator. The people-centric group once formed may subsequently interact in a multitude of ways with specific emphasis on one or more topics.

Other conventional Web-site service provides a one-to-one matching of individuals in an online environment. From the database of individuals, individuals'interests and defined characteristics can be automatically matched in an online community of users as indicated in U.S. Pat. No. 5,950,200.

### SUMMARY OF THE INVENTION

The present invention targets a specific group, i.e. to parents. More specifically, the present invention targets a group of parents—those with school-going children. The present invention overcomes the disadvantages of the prior art by automatically grouping parents based on the information provided by them when they register for an online social networking service (for example, information about their children's school, membership in a soccer club, mother's club, scout groups etc). The grouping algorithm of the present invention is deterministic and automated. The algorithm automatically groups parents who have shared interests and hence simultaneously forms both people and topic-centric groups. Further, the present invention is unique from the one-to-one matching mechanism since it pertains to groups of parents within social networks rather than to the matching of individuals.

It is, therefore, an object of the present invention to provide the algorithms and a method to classify and group parents that have come together in a randomly formed online social network.

It is another object to provide the algorithms and a method to enable parents within an online social network to sort member-generated content by using the grouping system identified in the present invention.

It is another object to provide the algorithms and a method to enable a point-based incentive system for content-generation by members within an online social network.

In a preferred embodiment, the present invention can classify and group parents in a structure that mimics the real world school relationships between their children and/or the real world groups that they or their children may belong to (for example, soccer club, mother's club, scout groups etc). By utilizing the database that parents have created while registering, such as information about themselves (ethnicity, religion, occupation, education, hobbies, interests etc.) and their children (school district, school name, grade, class, hobbies, interests etc.), the software algorithms may automatically proceed to group a community of parents within an online network of parents.

The present invention targets an online social network of parents. Online social networks grow and develop to create degrees of separation between users. Typically, parents of school going children have a strong affinity to each other even though their individual relationship may be defined by several degrees of separation in a randomly formed network. By applying the grouping algorithms of the present invention, individual parent-users' affinity relationships can be established by matching certain key profile attributes. Such key profile attributes may include (1) geographical and/or physical location, and (2) personal interest or/and hobbies. Examples of geographical and/or physical location may include, but are not limited to, the zip code, address, church or school or company location. Examples of personal interest and/or hobbies may include, but are not limited to, music, sports, or information about their children. When both geographical component(s) and personal interest component(s) are met together, a deterministic grouping algorithm that ensures high affinity between network members can be created aprori, and then can subsequently be applied to automatically group parent-users.

In a preferred embodiment, the present invention of the grouping algorithm can enable parent-users within an online social network to sort member-generated content using the grouping system. The groups of parent-users formed may have a relationship and hierarchy between themselves and the hierarchy has a direct relation to the affinity between group members and the value of user-contacts at the particular group level. Once such groups are formed the parent within the network can “filter”or sort all content using these group-level filters and thereby increase the value of the network to them.

In a preferred embodiment, the present invention of the grouping algorithm may develop a point-based incentive system based on the information generated by the members within an online social network. The value of an online social network of parent-users is directly related to the number of users and the content generated by these users. The online community will share the content produced by these users. The present invention addresses a means to create an algorithm to measure the value-added activity of network users and to reward this activity with points. These points are tied to a valuation model that allows the user to exchange accrued points for online/offline merchandising with affiliated partners. The value-added by content is directly related to the type of the content, its impact on network growth, and its quality and/or relevance.

In further accordance with the purpose of this invention, as embodied and broadly described herein, the invention is an apparatus that classifies and groups users in a networking database system for parents, comprising a first input means for receiving a first input from a first user indicating a user ID having a communication port containing a first set of data corresponding to a first user, the first set of data including the school geographical information of the first user's child and the personal interest of the first user and child; a first storing means for storing the first set of data in a database in a first record of the database; a second input means for receiving a second input from a second user indicating a user ID at the communication port containing a second set of data corresponding to a second user, the second set of data including the school geographical factors of the second user's child and the personal interest of the second user and child; a second storing means for creating a second record in the database corresponding to the second user; and an automatic grouping means, coupled to the first and the second input means, for determining a grouping relationship between the first set of data of the first user and the second set of data of the second user.

### BREIF DESCRIPTION OF THE DRAWINGS

Further features of the invention, its nature, and various advantages will be more apparent from the accompanying drawings, and the following detailed description in which like reference numerals refer to like elements and in which:

FIG. 1 is a block diagram of a computer system in accordance with a preferred embodiment of the present invention.

FIG. 2 is a flow chart showing steps performed in accordance with a preferred embodiment of the present invention to initiate and create an online network of parent-users.

FIG. 3 is a flow chart showing steps performed in accordance with a preferred embodiment of the present invention to enable a parent-user to register into the network, which requires the creation of a profile, and to store this record into the database.

FIG. 4 is an exemplary format of database for an online network of parents.

FIG. 5 is a block diagram showing an example of the grouping algorithm performed in accordance with a preferred embodiment of the present invention.

FIG. 6 is a flow chart showing steps performed in accordance with a preferred embodiment of the present invention to automatically group parents registering in the network.

FIG. 7 is an exemplary format of database showing grouping of parents.

FIG. 8 is a flow chart and web-screen example showing steps performed in accordance with a preferred embodiment of the present invention to enable a parent user to filter content using automatically created groups.

FIG. 9 is a flow chart showing steps performed and an exemplary database used in accordance with a preferred embodiment of the present invention to enable a parent user to earn reward points for content produced and to subsequently assign these points a currency denominated value.

FIG. 10 is an example of a home page of a web site used by a preferred embodiment of the present invention to enable user registration into the network.

### DETAILED DESCRIPTION OF THE DRAWINGS

Reference will now be made in detail to the preferred embodiments of the invention, examples of which are illustrated in the accompanying drawings. Wherever possible, the same reference numbers will be used throughout the drawings to refer to the same or like parts.

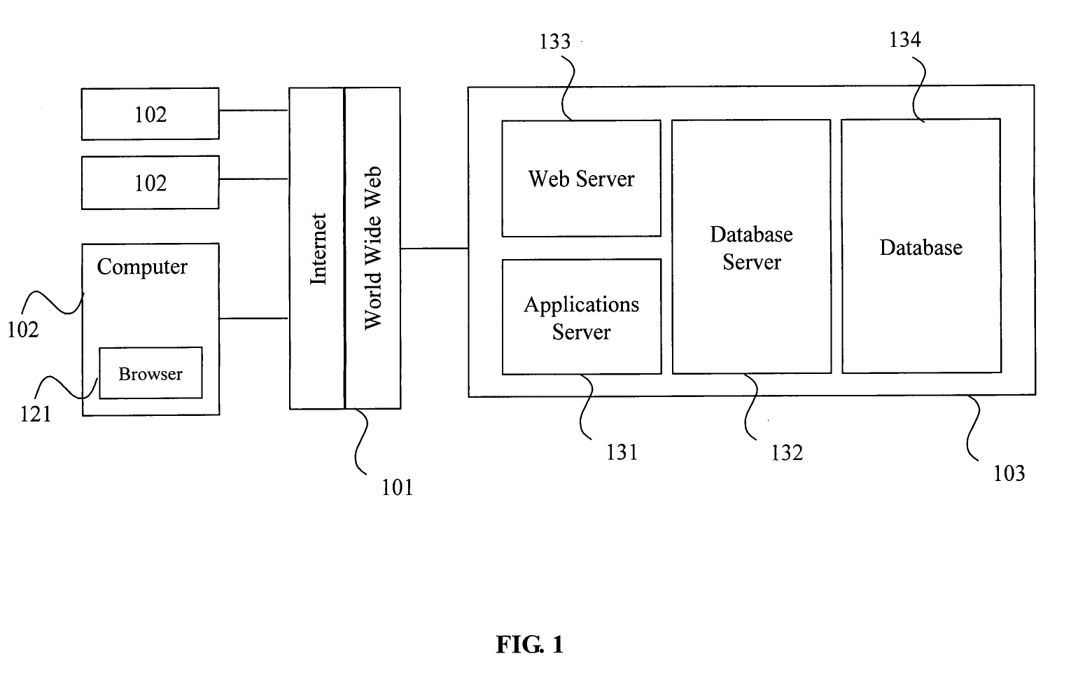

FIG. 1 is a block diagram of a computer and database system in accordance with a preferred embodiment of this invention. Computer system 102, referred to as a communication port, is typically a Windows based workstation, having a processor, memory, display and communication hardware and software enabling connection to the internet, that are not shown in the Figure for clarity of purpose since these will be understood by persons of ordinary skills. The Browser 121 is software which is most relevant to the invention and enables a parent-user to connect to the internet and web 101. The system embodies a plurality of users and computers 102 as shown in FIG. 1. Database system 103, will be used by the database service provider to provide database services to users through the web 101. The database service provider in the embodiment of this invention provides online social network services to parents. The Applications server 131 is a conventional device that can be used to store and run various applications such as electronic mail. The Web server 133 is typically a programmed computer that handles requests for records, documents and other services and transmits such information over the web 101. Database server 132 is generally configured using software programming and is used to communicate with the database 134. Database 134 is a typical storage medium as is well-known.

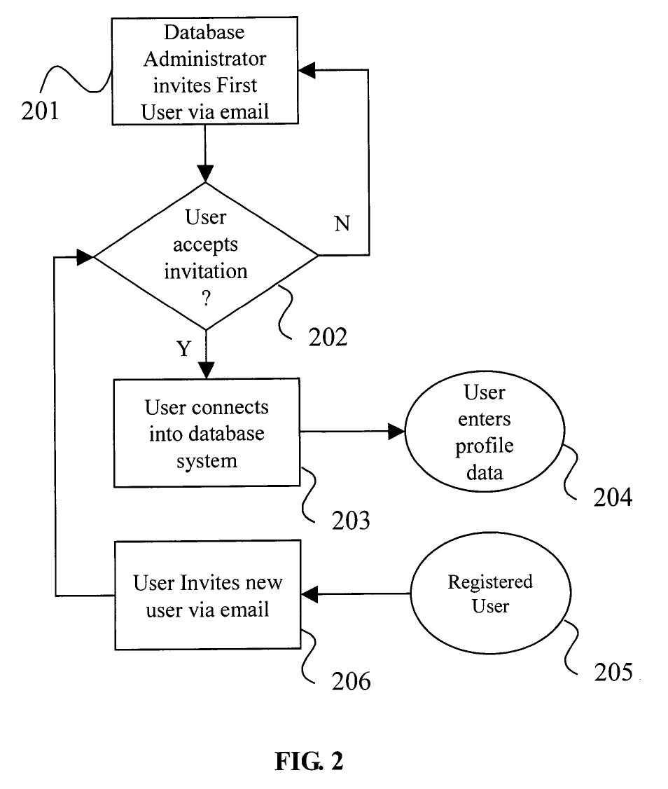

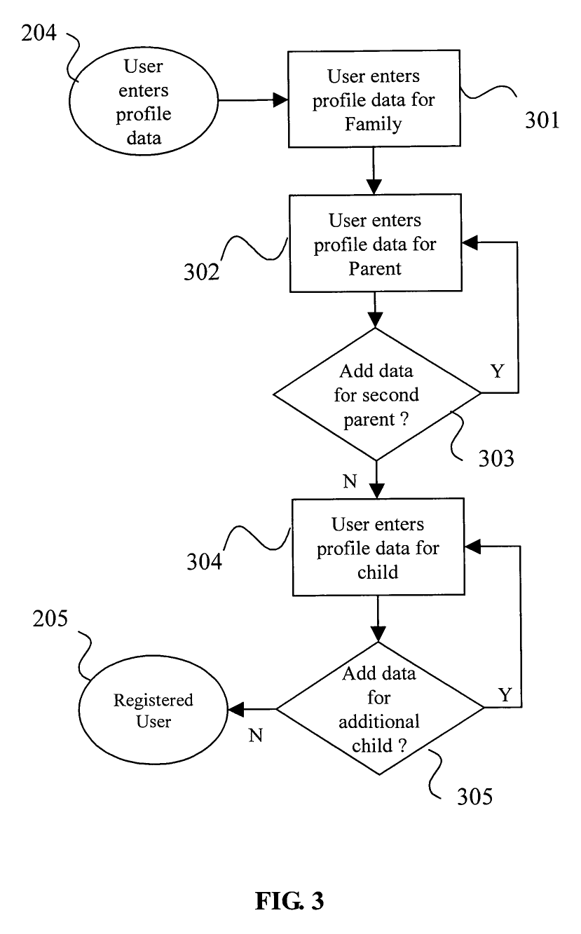

FIG. 2 is a flow chart showing steps performed in accordance with a preferred embodiment of the present invention to initiate and create an online network of parent-users. In step 201, the database administrator responsible for the database system 103 sends an “invitation to join” email to the first user of the network through the application server 131. The parent-user uses the computer system 102 and any email client software to receive the invitation email. In step 202, if the user does not want to join the network the database administrator invites a new first user in step 201. If the user accepts the invitation in step 202, the user is able to click on a web link that is embodied within the invitation email and subsequently provided access via the browser 121 to the web server 133 on the database system 103 as shown in step 203. In step 204 the user enters personal profile data into the database system 103 using the browser 121 and web-based application software provided by the database service provider using the web server 133 and application server 131. Upon entry of profile data the user is registered into the network as shown in step 205. The profile entry and registration process, by which the user creates a database record in the database 134, will be described in more detail in FIG. 3. Once a user is registered into the network the user is able to invite other users into the network using the browser 121, the application server 131 and web server 133. This process of user registration and invitation continues until a randomly formed network of parent users each with profile data stored as records in the database 134 is created.

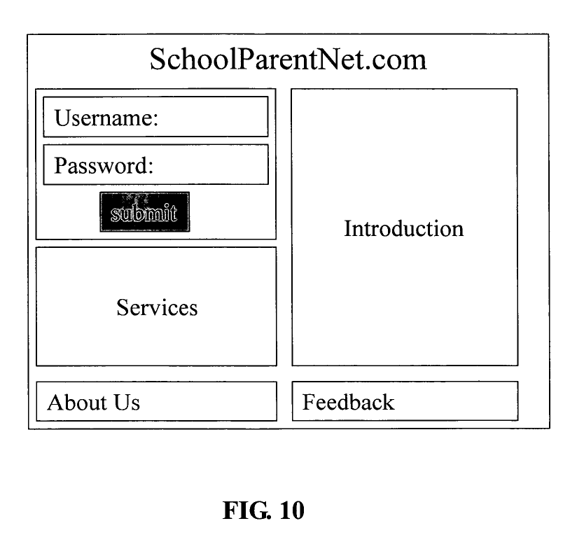

FIG. 3 is a flow chart showing steps performed in accordance with a preferred embodiment of the present invention to enable a parent-user to register into the network, which requires the creation of a profile, and to store this record into the database. In step 301 through step 305, the parent-user performs the process of profile data entry which requires the use of the browser on the users computer system 102, to connect via the internet 101 to the web server 133, applications server 131 and database server 132 at the database service providers side and to subsequently create a database 134 record that specifically pertains to the parent-user. For each of these steps the parent-user is provided with entry fields on the browser through a software application that is served by the web server and furnished by the application server. The entries made by the user are captured by the database server and are stored as records in the database 134 in pre-defined locations related to the entry field and the specific user. In step 301 the parent provides data that is relevant to the entire family, including a unique username and password, which will enable the parent to register into the network. The parent also provides information such as a family photograph, the address of the residence including state and zip code information. The database server 132 presents relevant school information to the user during step 304 using information about the user's state of residence. In step 302, the parent-user enters profile data for any one parent including contact information, occupation/education/ethnicity/religion information and hobbies/interest information (including membership in groups such as mother's clubs, book clubs etc). In step 303, the user can decide to add information about a second parent using an “Add parent”feature presented by the Web-based application software on the user's browser 121. In step 304, the parent-user enters information about a child including school information such as school district, school name, grade and classroom name. The user is able to select the appropriate school information from data that has been pre-loaded into the database 134. Using Web-based application software presented via the browser 121, the parent-user selects the relevant school information and associates this data with their records. The parent-user is also able to enter profile data pertaining to hobbies and interests of their child (including membership in groups such as soccer clubs, scout groups etc). In step 305, the user can decide to add information about an additional child using an “Add child” feature presented by the Web-based application software on the user's browser 121. In order to facilitate an easy to use and convenient registration flow, the online social network service provider may split the registration flow into smaller steps each requiring incremental data from the user. The user may also be able to partially register and then resume profile completion at a subsequent point in time. Under this scenario the user can logout of the network through his browser 121 thereby breaking the connection through the internet 101 to the database system 103, as shown in FIG. 1. The user is able to register into the network again through the browser 121 and the database system service providers home page as shown in FIG. 10, by using the users own unique username and password. Once the user is registered into the network the user is back at step 301, 302, 304 or 205 depending upon the completion of the users profile. As shown in FIG. 2, once the user decides to add no more children the registration process is complete as indicated in step 205.

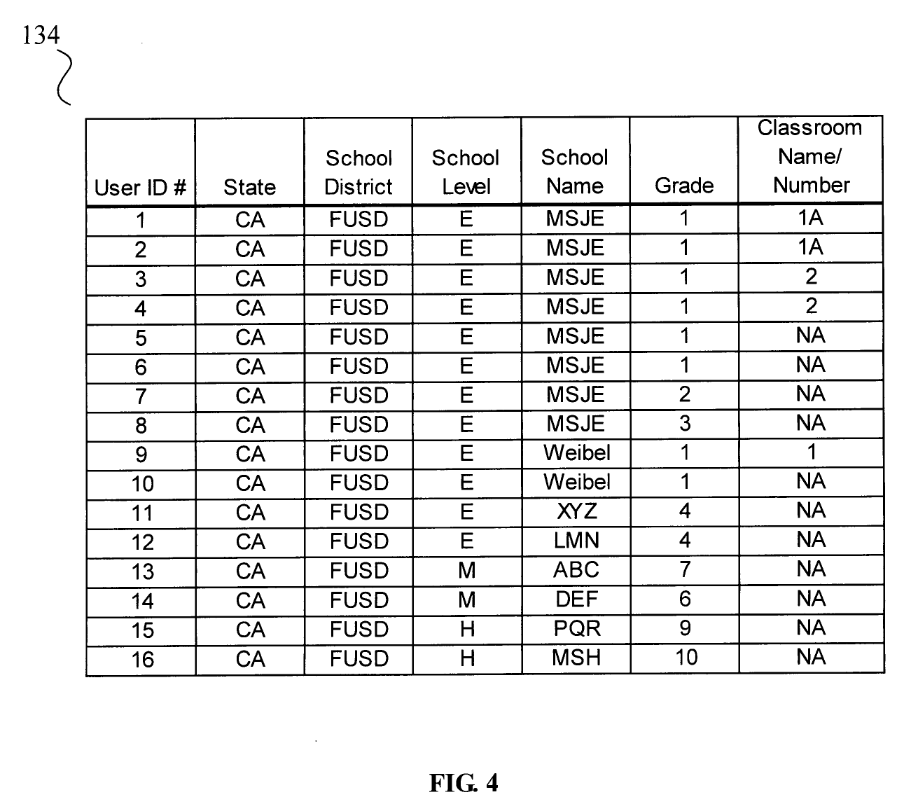

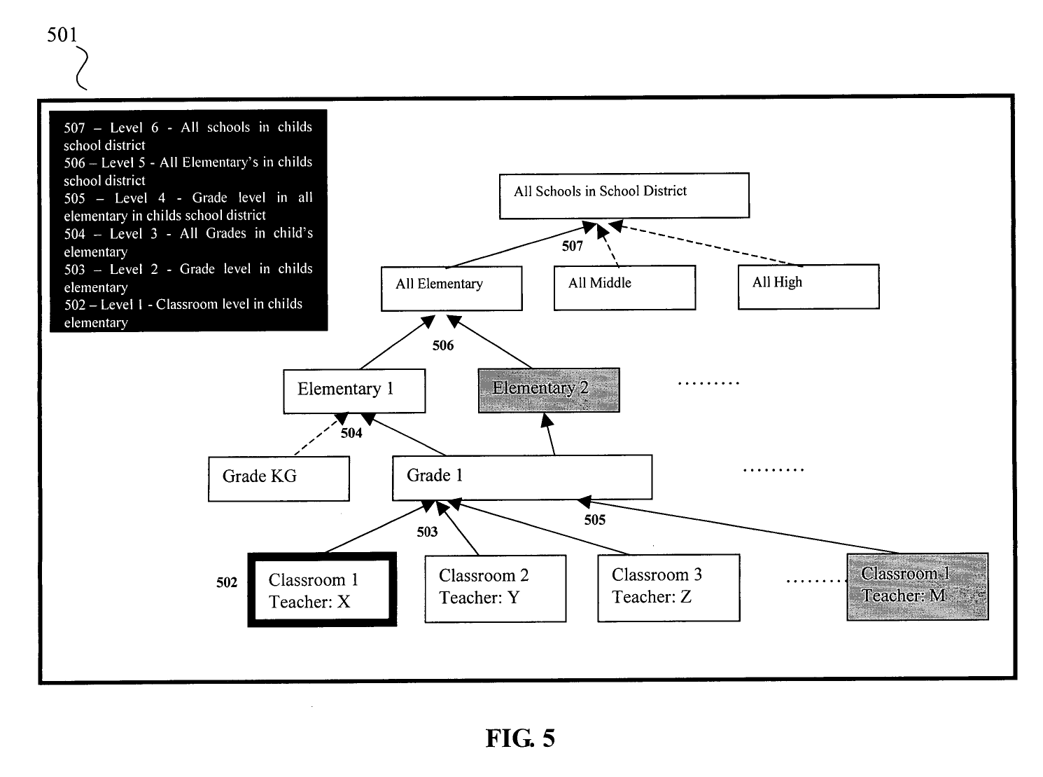

FIG. 4 shows an exemplary parent-user profile database used in conjunction with the described embodiment. It will be understood that the format shown is provided only for the purposes of example and that any appropriate database and database format can be used to implement the present invention. Only the relevant portions of the database that are used for the grouping algorithm based on a users child's school are presented in the figure for clarity of purpose. The school based grouping algorithm has been described in detail in FIGS. 5, 6 and 7. The method used to group parents based on other real world groups (such as soccer club, mother's club, scout groups etc.) is similar and forms a subset of the flow described herein. In all cases, database information provided by the user is used to group parents, by first automatically creating a group if the group does not exist and to subsequently add users automatically into these groups as they register. Database record entry related to contact information, occupation, industry, education, ethnicity, religion, hobbies and interests are not presented since persons of ordinary skills will understand these. Each username is assigned a user ID number in the database 134. All profile database records relevant to this parent-user are linked to the User ID number.

FIG. 5 is a block diagram showing an example of the grouping algorithm performed in accordance with a preferred embodiment of the present invention.

In step 501 it is shown that the present invention can classify and group the parents in a structure that mimics the real world school environment whereas their children are connected in an identical manner in their school environment. It will be understood that the example shown is provided only for the purposes of illustration and that the algorithm is generally applicable to any school system and can be used to implement the present invention (for example school district information can be replaced by zip code or city name for private schools and pre-schools/day-cares). In this particular example the grouping algorithm is applied to a parent-user who has a child that attends Grade 1, Classroom 1 in a specific elementary school in a specific school district.

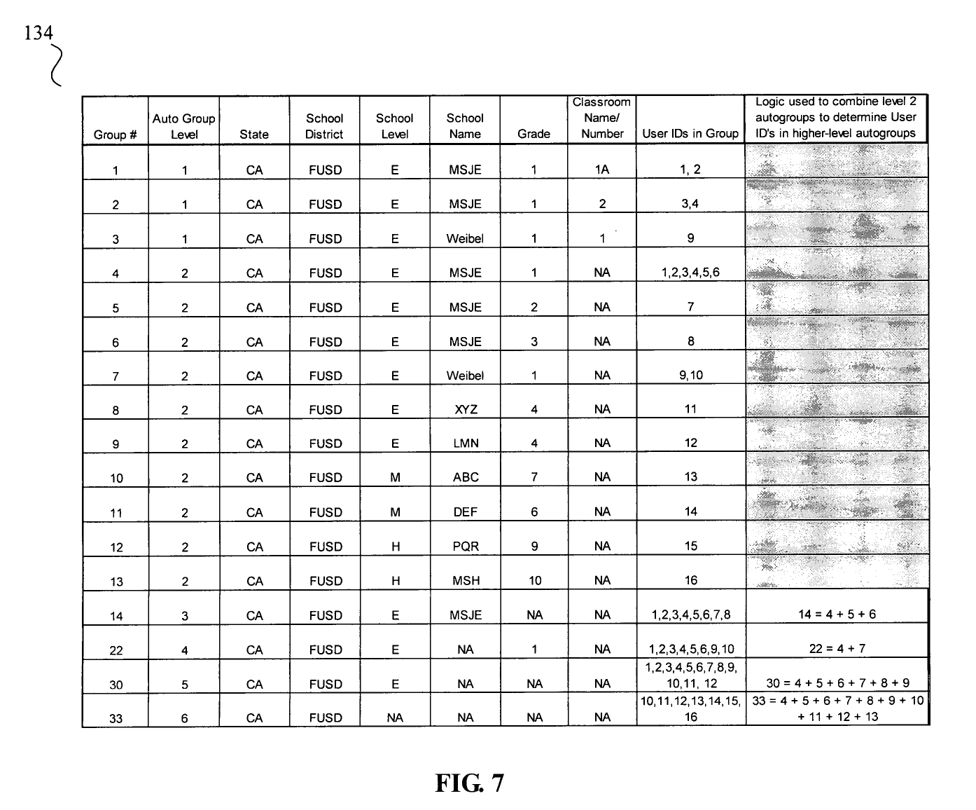

In step 502, the parent is grouped with other parents in the network who have children in Classroom 1 within the specific elementary school. The parent is associated with a user ID and a set of records within the database 134. The application software combines the records of all parents with similar classroom records to form a group as described in step 502. The records of this combined group are the stored into the database 134. This process of grouping and storage is performed for all levels shown graphically in FIG. 5 and in a sample database in FIG. 7. In step 503, the parent is grouped with other parents in the network who have children in Grade 1 within the specific elementary school. In step 504, the parent is grouped with other parents in the network who have children in all grades within the specific elementary school. In step 505, the parent is grouped with other parents in the network who have children in Grade 1 within all elementary schools in the specific school district. In step 506, the parent is grouped with other parents in the network who have children in any elementary school in the specific school district. In step 507, the parent is grouped with other parents in the network who have children in any school in the specific school district. This figure shows that the groups of parent-users formed can have a relationship and hierarchy between themselves and the hierarchy has a direct relation to the affinity between group members and the value of user-contacts at the particular group level.

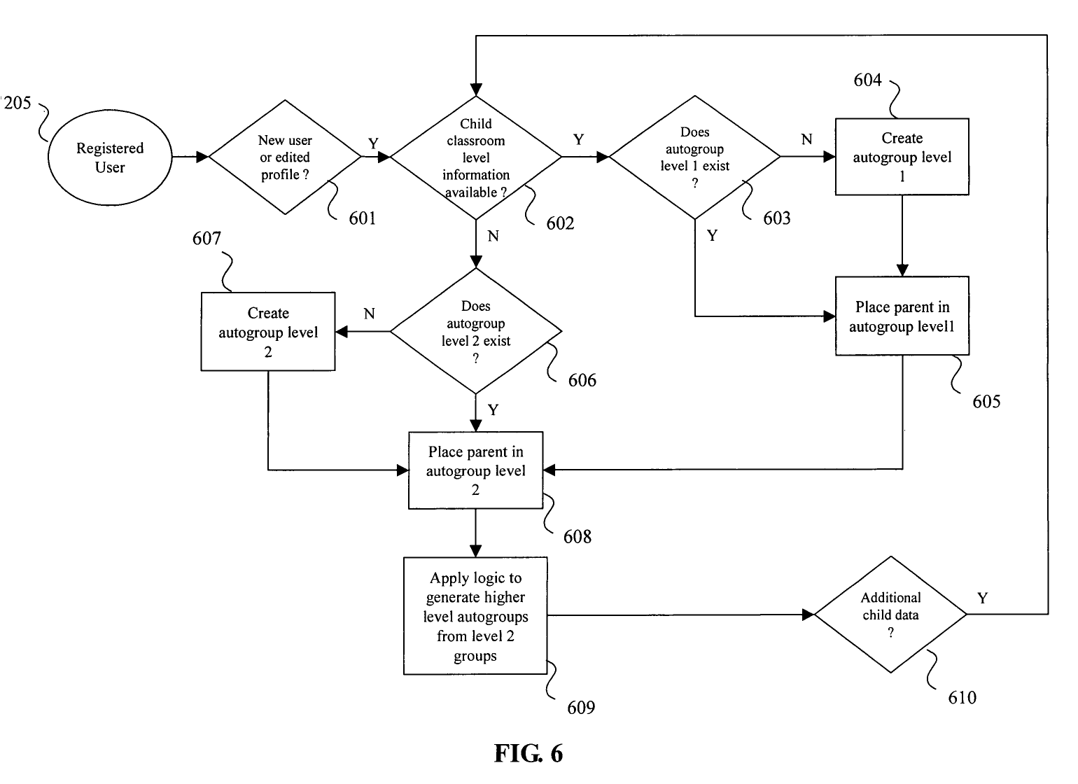

FIG. 6 is a flow chart showing steps performed in accordance with a preferred embodiment of the present invention to automatically group parents registering in the network.

In step 601 through 609, the application software, that has been created by the online social network/database service provider and contains the grouping algorithm of the present invention, performs a series of logical operations on the parent-user records stored in the database 134. The outcome of the process results in new records that reflect the groups and the users within each group and these records are also stored into the database 134.

Step 601 is triggered when a user registers into the network for the first time as indicated in step 205. Users provide profile information for at least one parent and one child and hence the grouping algorithm can be applied upon completion of registration. Likewise any changes to a parent-users profile information triggers step 601. In step 601 the database system 103 performs a logical operation comparing group records in the database to the users profile data. The parent-users child's school record is used to determine if a group with a similar record already exists in the database 134 as shown in step 602. A school record at step 602 is defined by the state, school district, school level (example elementary, middle, high), school, grade and classroom. If a group record exists then the parent-user ID is added to this group record as shown in step 605. A group record would exist apriori if another parent-user already has registered into the network with the same school record. If the group record does not exist the school record for the classroom level group is created as shown in step 604 and subsequently the parent-user ID is added to this group record. In step 606, the parent-users child's school record is used to determine if a group with a similar record already exists in the database 134. A school record at step 606 is defined by the state, school district, school level (example elementary, middle, high), school, and grade. If a group record exists then the parent-user ID is added to this group record as shown in step 608. If the group record does not exist the school record for the grade level group is created as shown in step 607 and subsequently the parent-user ID is added to this group record. Hence every registering parent-user ID is linked to either a grade and classroom level group record or only a grade level group record. A parent must provide at least grade level profile data and so one of these two outcomes is designed into the database system 103. In step 609 the application software applies logic to group records at the grade level (2) and combines these records in a deterministic manner as specified by the application software algorithm stored in the application server 131. The logic uses group level 2 record fields such as school district, school level, school and grade to create higher level group records and subsequently links parent-user IDs to the higher level groups formed. In step 610 the process is repeated for every child for whom the parent has entered profile data. A sample database reflecting this logical operation is shown in FIG. 7.

FIG. 7 shows an exemplary group database used in conjunction with the described embodiment. It will be understood that the format shown is provided only for the purposes of example and that any appropriate database and database format can be used to implement the present invention. Each group is assigned a unique group number and has associated records that are stored in the database 134. Parent-user IDs associated with each group are determined by using the grouping algorithm that is referred to in the present invention.

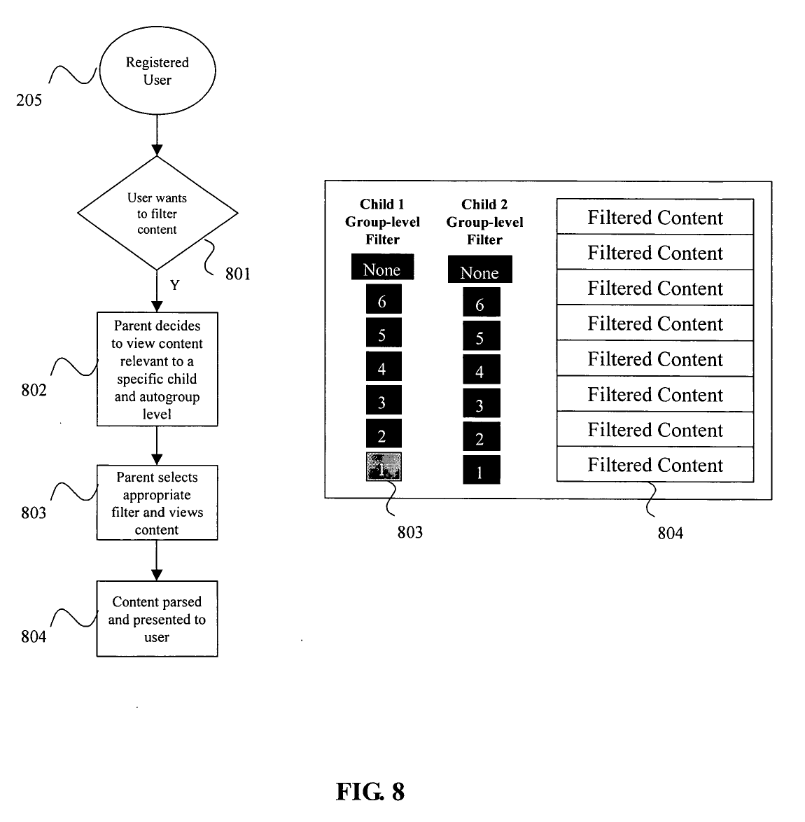

FIG. 8 is a flow chart and web-screen example showing steps performed in accordance with a preferred embodiment of the present invention to enable a parent user to filter content using automatically created groups.

In step 801 that parent-user determines to view and filter member generated content in the database 134. Filtering content using the hierarchical grouping system increases the relevance of the content to the user. The hierarchy of the groups in itself is directly related to the affinity between group members and hence the content produced by group members related at the lowest group levels has a higher value than the content produced by higher-level group members. The filtering mechanism for member-generated content is enabled by tagging each member-generated content record with the user ID and subsequently group IDs of the member that has generated this content. Hence any subsequent user that would like to view content generated only by members of a specific group can do so and the applications software created by the database service provider is able to sort the content and to deliver only the pertinent content requested. In steps 802-804, the parent-user uses the browser 121 to make a request to filter content delivered. The web server 133 delivers the filtering screens used by the users browser 121. The application server 131 provides the application software program that works in conjunction with the database server 132 to sort the content stored in the database 134 and to deliver the results, which is the filtered content, back to the user through the web server 131 over the internet 101 and to be displayed using the users browser 121.

In step 802 the parent-user decides to view content generated by members of a specific group. Since the grouping method described places the parent-user into groups for each unique child's school data, the parent must first decide which child's related groups the user wishes to use in the filtering process. In step 803 the user uses the application screen as shown in FIG. 8 that is displayed using the browser 121 to make a selection of the filter. The filter selection is related to the group level and the specific child. This selection enables the application software to determine which groups and member-generated content must be sorted and presented to the user as shown in step 804. Only content that has been generated by the members of a specific group is presented to the user. The filtering method used to sort content for parents registered as belonging to other real world groups (such as soccer club, mother's club, scout groups etc.) is similar and forms a subset of the flow described herein. The filtering mechanism is a powerful method to increase value of content to the user and it is able to deliver this value very rapidly. As example if we assume a user is reviewing member-generated content on teacher references. In a network of parents in the entire country (i.e., U.S.A), there will likely be many records in the database for member-generated references on teachers. In order to very rapidly access information pertinent to a users specific child the parent-user can select a classroom level (1) filter for that child and rapidly gain access to highly relevant content. In this example it is evident that the filter level can also be used to increase relevancy of data as it pertains to the specific nature of the content. Another example could entail a user seeking to understand school performance across a certain school district. Here the user may have interest in searching for content relevant to a child at a district level (6). Alternatively the user may choose to review information from outside the school district of any of their children and select the “no filter” option in step 803.

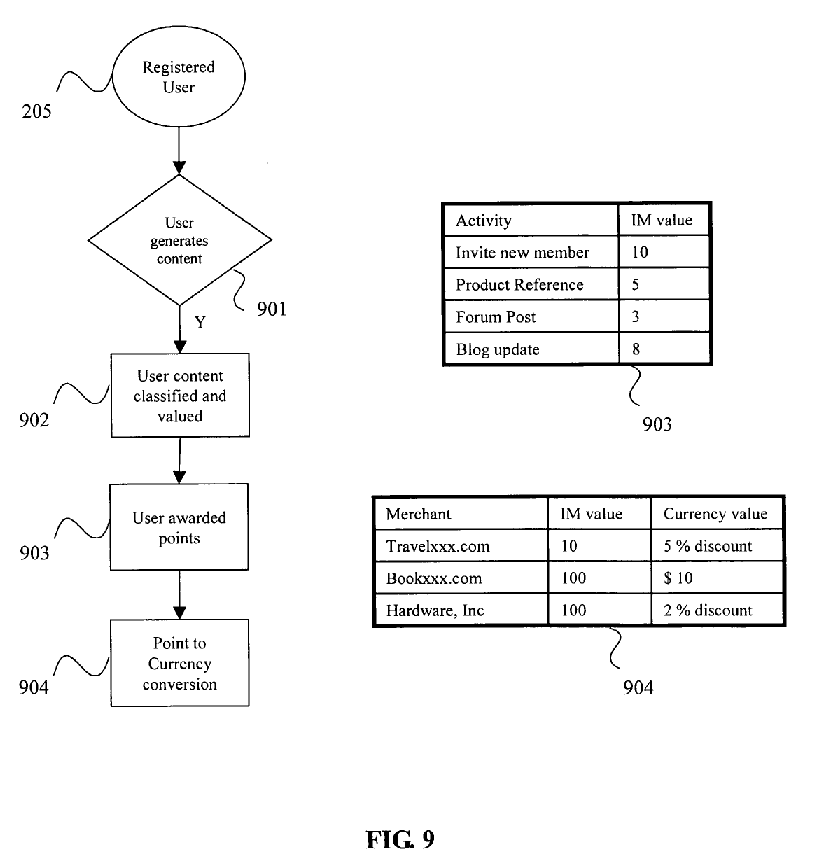

FIG. 9 is a flow chart showing steps performed and an exemplary database used in conjunction in accordance with a preferred embodiment of the present invention to enable a parent user to earn reward points for content produced and to subsequently assign these points a currency denominated value.

In steps 901-904, the parent-user uses the browser 121 to interact with the database system 103 through the internet 101. During this interaction the web server 133 serves up requests made by the user through the browser 121, based on application software stored on the applications server 131, and data delivered by the database server 132 from and to the database 134. The applications software tracks specific activities performed by the user related to content generation and for each such function performed the applications software assigns points to the user which are stored as a record in the database 134 and are linked to the users ID. In step 901 the user generates content by using the application software provided by the database service provider. In steps 902 and 903, the content generated by the user is classified and valued commensurate with the value added to the network and the member is awarded points as an incentive for their activity. The algorithm used for classification and valuation of these points is directly related to the type of the content, its impact on the network growth, and its quality and/or relevance. Mathematically we express this algorithm as follows. We first express a relationship between number of members and the member-generated content, wherein:
MC=f(NM), where MC=member-generated content, f=function, and NM=number of network members.
It is possible to create a multiplier that boosts the member-generated content as shown,
MC=IM * f(NM), where IM is an incentive multiplier.
Incentives for the online network of parents enable parent-users to earn points for content generated by them. The value of IM is directly related to the member content generation activity and is assigned by the database provider in the applications software algorithm.

An exemplary format for value of IM for different activities is shown in step 903. It will be understood that the example shown is provided only for the purposes of clarity and that any appropriate valuation model can be used to implement the present invention.

In step 904, the user is able to convert the points to currency denominated value. The currency points are assigned by the database service provider and associated merchant affiliates who have agreed to convert user point awards into cash value. The valuation model is based on merchant and database service provider agreements. The merchant can be an online or an offline vendor. An exemplary format for value of IM for merchants is shown in step 904. It will be understood that the example shown is provided only for the purposes of clarity and that any appropriate valuation model can be used to implement the present invention.

FIG. 10 shows an example of a home page of a web site used by a preferred embodiment of the present invention to enable user registration into the network. The parent-user who is already a registered member of the network is able to reconnect with the database system 103 through the Internet 101 using the browser 121. The parent inputs the username and password records that are associated with their unique parent user ID in the database 134. Upon authentication of the user's information the parent is “logged into” the database service providers network upon which time the user is now at step 205 as depicted in FIGS. 2, 3, 6, 8, & 9. Following step 205 the user has access and can perform various network functions as outlined in the present invention.

Although the present invention has been illustrated and described with reference to the preferred embodiment thereof, it should be understood that it is in no way limited to the details of such embodiment but is capable of numerous modifications within the scope of the appended claims.

What is claimed is:

1. A method for classifying and grouping parent-users within a network database system, having a communication port, connected via the internet to a database system comprising of a web-server, an applications server, a database server and a database capable of storing a plurality of records:
(a) receiving a first input from a first user indicating a user ID at said communication port containing a first set of data corresponding to a first user, said first set of data including the school geographical information of said first user's child and the personal interest factors of said first user;
(b) storing said first set of data in a first record of said database;
(c) receiving a second input from a second user indicating a user ID at said communication port containing a second set of data corresponding to a second user, said second set of data including the school geographical information of said second user's child and the personal interest factors of said second user;
(d) creating a second record in said database corresponding to said second user; and
(e) determining a grouping relationship wherein said second user is automatically grouped with said first user based on the relationship of said first set of data of said first user and said second set of data of said second user.

2. The method of claim 1 wherein step (a) includes receiving input from said first user through the World Wide Web.

3. The method of claim 1 wherein step (a) includes receiving input from said first user by way of software executing on an online service.

4. The method of claim 1 wherein steps (e) is performed immediately after receiving user input.

5. The method of claim 1 wherein said school geographical information of said users' children include zip code, city name, school district, school level, school name, children's grade or class.

6. The method of claim 1 wherein said users' personal interest factors include said users' personal hobbies.

7. The method of claim 1 wherein said users' personal interest factors include said users' and their children's personal information.

8. The method of claim 1 wherein said users' personal interest factors include their children's interests.

9. The method of claim 1, further comprising the steps of:
registering said first user and said second user; and
assigning a password to said first user and said second user.

10. The method of claim 1 further comprising filtering user-generated content by said users, based on said users' set of data, as each user-generated content record is connected with said users' ID which in turn is connected to said users' set of data.

11. The method of claim 10, further comprising the steps of:
registering said first user and second user; and
assigning a password to said first user and second user

12. The method of claim 11 wherein said users' set of data includes school geographical information of users' children including zip code, city name, school district, school level, school name, children's grade or class.

13. The method of claim 11 wherein said users' set of data includes personal interest factors including said users' personal hobbies.

14. The method of claim 11 wherein said users' personal interest factors include said users' and their children's personal information.

15. The method of claim 11 wherein said users' set of data includes users' personal interest factors including their children's interests.

16. The method of claim 11 further comprising generating a point-based incentive algorithm directly relating to the type of said member-generated content, its impact on the network growth, and its quality and/or relevance, wherein a formula expressing a relationship between said users and said user-generated content is described as:
MC=f(NM), wherein MC=member-generated content, f=function, and NM=number of network members.

17. The method of claim 11 further comprising generating a point-based incentive algorithm directly relating to the type of said member-generated content, its impact on the network growth, and its quality and/or relevance, wherein a formula expressing a relationship between said users and said user-generated content is described as:
MC=IM * f(MN), wherein MC=member-generated content, f=function, and IM=incentive multiplier directly related to the member content generation activity.

18. An apparatus that classifies and groups parent-users within a networking database system for parents, comprising:
(a) a first input means for receiving a first input from a first user indicating a user ID having a communication port containing a first set of data corresponding to a first user, said first set of data including the school geographical information of said first user's child and the personal interest factors of said first user;
(b) a first storing means for storing said first set of data in a database in a first record of said database;
(c) a second input means for receiving a second input from a second user indicating a user ID at said communication port containing a second set of data corresponding to a second user, said second set of data including the school geographical factors of said second user's child and the personal interest factors of said second user;
(d) a second storing means for creating a second record in said database corresponding to said second user; and
(e) an automatic grouping means, coupled to said first and said second input means, for determining a grouping relationship between said first set of data of said first user and said second set of data of said second user.

19. The apparatus of claim 18, further comprising a content filtering means for filtering said user-generated content created by said users by tagging each said member-generated content record with said users' set of data.

20. The apparatus of claim 18, further comprising a point-based incentive calculating means directly relating to the type of said member-generated content to measure value-added activity of said users and to reward said activity with points.
